(19) United States
(12) Patent Application Publication
(10) Pub. No.: US 2026/0288085 A1
(43) Pub. Date: Sep. 24, 2026

(54) APPARATUSES AND METHODS TO AUTOMATE SAFETY MECHANISMS FOR ROLLING SYSTEM IN MANUFACTURING PLANTS

(71) Applicant: D-Riven Automotive Solutions LLC, Canton, MI (US)

(72) Inventors: George Morrison III, Canton, MI (US); Adam Nine, Canton, MI (US); Timothy B. Rood, Canton, MI (US); Robert Bruckman, Rochester Hills, MI (US)

(21) Appl. No.: 19/085,531

(22) Filed: Mar. 20, 2025

(51) Int. Cl. G05B 9/02

(52) U.S. Cl. CPC G05B 9/02

(57) ABSTRACT

The present invention relates to an automated safety mechanism for rolling systems in manufacturing plants, particularly for thermoplastic and thermoset sheet processing. The system prevents accidental roller closure during maintenance using a high-strength stop block actuated by hydraulic, pneumatic, or electromechanical mechanisms. An intelligent control system integrates sensors, feedback loops, and fail-safes to ensure precise deployment and retraction. The mechanism operates in automatic, manual, and emergency stop modes, enhancing worker safety and equipment protection. Additionally, network connectivity enables remote monitoring, predictive maintenance, and diagnostics, optimizing operational efficiency while reducing downtime and the risk of injury in industrial rolling applications.

### FIELD OF THE INVENTION

The invention relates to safety mechanisms employed in manufacturing plants, particularly in the context of rolling systems utilized in thermoplastic and thermoset sheet processing.

### BACKGROUND OF THE INVENTION

Rolling systems are integral components in the processing of thermoplastic and thermoset sheets within manufacturing plants. These systems employ rollers set at fixed distances to facilitate the formation of sheets with precise tolerances. Safety concerns arise during maintenance procedures when operators manually clean the rollers, risking injury from accidental closure. Existing safety measures, such as manual insertion of metal blocks, are prone to human error and inefficiency. Thus, there is a need for an automated safety mechanism to enhance safety protocols during roller maintenance.

### BRIEF SUMMARY OF THE INVENTION

The present invention provides an automated safety mechanism for rolling machines used in manufacturing plants, particularly for the processing of thermoplastic and thermoset sheets. This safety mechanism is designed to prevent accidental roller closure during maintenance operations, thereby enhancing worker safety and minimizing the risk of injury. It utilizes a variety of mechanical extension mechanisms, such as pistons, actuators, and hydraulic or pneumatic forces, to deploy a stop block that physically obstructs the movement of the rollers. The stop block is constructed from high-strength materials, including hardened steel and tungsten carbide, ensuring durability and reliability under high-stress conditions. The system integrates advanced control systems with sensors and actuators to automate the deployment and retraction of the stop block, providing a fail-safe feature that maintains the safety and efficiency of the rolling system during maintenance. This invention addresses the shortcomings of existing manual safety measures, offering a robust and automated solution to enhance safety protocols in industrial rolling applications.

### BRIEF DESCRIPTION OF THE DRAWINGS

The following drawings illustrate by way of example and are included to provide further understanding of the invention for purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature or a feature with similar functionality. In the drawings:

FIG. 1 illustrates a schematic representation of a method according to a first embodiment of the invention.

FIG. 2(a)-(d) illustrate a rolling machine according to a second embodiment of the invention.

FIG. 3(a)-(d) illustrate a rolling machine according to a third embodiment of the invention.

FIG. 4(a)-(d) illustrate a rolling machine according to a fourth embodiment of the invention.

FIG. 5(a)-(d) illustrate a rolling machine according to a fifth embodiment of the invention.

FIG. 6(a)-(d) illustrate a rolling machine according to a sixth embodiment of the invention.

FIG. 7 illustrates a schematic representation of a control system to control the automated stop blocks according to a seventh aspect of the invention.

### DETAILED DESCRIPTION OF THE INVENTION

The present invention provides an automated safety mechanism for use in manufacturing plants employing rolling systems, particularly in the processing of thermoplastic and thermoset sheets. The invention addresses safety concerns associated with the manual cleaning and maintenance of rollers within these systems, mitigating the risk of injury to operators and minimizing equipment damage.

The automated safety mechanism disclosed herein is designed to enhance safety during the maintenance of rolling systems in manufacturing plants. At its core, the mechanism prevents accidental closure of rollers by obstructing their movement when disengaged for cleaning. Each embodiment below accomplishes this through unique features, such as sliding plates, T-shaped components, or pivoting arms, each engineered to effectively block roller movement without impeding normal operation. Mechanisms for extension, including pistons, actuators, or mechanical linkages, facilitate controlled disengagement of the safety device.

In the exemplary embodiments disclosed herein, the automated safety mechanism comprises various designs, each offering unique features and advantages. It should be understood that the following embodiments are provided for illustrative purposes and is not intended to limit the scope of the invention.

### Rolling Machines

Rolling machines are indispensable in manufacturing processes, particularly for producing thermoplastic and thermoset sheets. These machines feature multiple rollers that can vary in diameter, designed to shape and form materials with high precision. The rollers, made from durable materials like steel or other alloys, are arranged either vertically or horizontally, and the gaps between them can be adjusted to accommodate different material thicknesses.

The housing of a rolling machine, constructed from strong materials such as steel or aluminum, provides stability and support for the entire system. It encloses the rollers and other mechanisms, ensuring structural integrity and protection. The design includes support elements like frame-roller supports, which help bear the weight of the rollers and maintain their positions during operation.

Electronics play a crucial role in controlling the rolling machines, with systems for adjusting the rollers, monitoring their positions, and ensuring safety during operation. These control systems often include sensors, actuators, and automated safety mechanisms like stop blocks, which prevent accidental closure of the rollers during maintenance.

The overall size and weight of rolling machines can vary significantly depending on their specific applications and the materials they are designed to process. They are designed to handle high-pressure operations and are built to last, ensuring reliability and efficiency in manufacturing environments. The materials used for the frame and other components are selected for their strength and durability to withstand the demands of continuous industrial use.

The inventive, automated stop block system may be designed for seamless integration with existing rolling machines, whether as an original equipment manufacturer (OEM) component or as a retrofit. Mounting assemblies for the stop blocks are engineered to attach to various frame configurations, ensuring adaptability across different roller arrangements. The mounting assembly may include brackets, fasteners, or welded connections depending on the structural requirements of the rolling machine. Additionally, certain embodiments may employ shock-absorbing mounts to mitigate impact forces when the stop block is engaged. These features ensure that the stop block system can be implemented without extensive modifications to the rolling machine while maintaining operational stability.

### Rollers

Rolling machines are essential in various manufacturing processes, particularly for producing thermoplastic and thermoset sheets. These machines are characterized by their versatility in size, configuration, and materials used, which allows them to cater to a wide range of industrial applications. They feature multiple rollers, which can vary significantly in size. Roller lengths include 36 inches, 48 inches, 60 inches, and 72 inches. The diameters of these rollers can also vary widely, with sizes being 6 inches, 10 inches, 12 inches, 14 inches, 16 inches, 18 inches, and 20 inches. These dimensions can be adjusted based on the specific requirements of the manufacturing process and the materials being processed.

The rollers themselves are made from various durable materials to withstand the high pressures and stresses encountered during the rolling process. Materials include chrome and stainless steel, which provide excellent strength and corrosion resistance. Other materials used in roller construction can include various alloys and composites, as will be explained below, chosen for their specific properties such as hardness, durability, and resistance to wear.

Each roller generally consists of two main components: the roller body and the support body. The roller body is the outer part of the roller that comes into direct contact with the material being formed into sheets. It is designed to roll and shape the material with high precision. The support body, which runs through the center of the roller body, has a smaller diameter and serves to mount the roller body to the rolling machine. The support body may also include mechanisms to lock it to a rotor, chain, gear, sprocket, or other devices that induce the support body to turn, thereby rotating the entire roller assembly.

The number of rollers in a machine is not particularly limited. In the accompanying embodiments, the inventors have put forward rolling machines with three rollers. But as few as one roller or as many as a dozen can be in a rolling machine. More rollers increase the complexity of keeping the rolling machines safe. And each roller that moves for cleaning or maintenance could benefit from a stop block according to the present invention.

The housing of a rolling machine is constructed from robust materials such as steel or aluminum, providing stability and support for the rollers and other components. The housing encloses the rollers and associated mechanisms, ensuring protection and structural integrity. It also includes support elements like frame-roller supports, which help bear the weight of the rollers and maintain their positions during operation.

Electronics play a crucial role in controlling rolling machines, with systems for adjusting the rollers, monitoring their positions, and ensuring safety during operation. These control systems often include sensors, actuators, and automated safety mechanisms like stop blocks, which prevent accidental closure of the rollers during maintenance. These safety features are essential to protect operators and ensure that maintenance can be carried out safely and efficiently.

The overall size and weight of rolling machines can vary significantly depending on their specific applications and the materials they are designed to process. They are designed to handle high-pressure operations and are built to last, ensuring reliability and efficiency in manufacturing environments. The materials used for the frame and other components are selected for their strength and durability to withstand the demands of continuous industrial use. This versatility in design and material selection allows rolling machines to be customized for a wide range of manufacturing processes, enhancing their utility and effectiveness in producing high-quality thermoplastic and thermoset sheets.

To enhance compatibility with stop block engagement, rollers may incorporate specific surface treatments or coatings that provide wear resistance and minimize friction. Common surface treatments include nitriding, hard chrome plating, or thermal spray coatings such as tungsten carbide or ceramic overlays. These treatments improve the longevity of both the roller and the stop block by reducing surface wear when the stop block is engaged. Additionally, in cases where non-metallic stop blocks are used, anti-static or non-stick coatings on the roller surface may prevent material buildup, further improving operational efficiency.

### Stop Blocks

By “stop block,” whether capitalized or not, the inventors mean any rigid material that can act as a barrier between two rollers to reasonably mechanically stop them from collapse them on top of each other. A stop block may be conformed to the shape of the rollers. Desirable material properties for stop blocks and other safety mechanisms include high tensile strength, compressive strength, hardness, and impact resistance. These properties ensure that the stop block can withstand the forces exerted by the rollers during operation and maintenance without failing or deforming. Materials for stop blocks include hardened steel and tungsten carbide, which offer a balance of strength, hardness, and durability.

The Young's modulus and/or compressive modulus of the materials used for stop blocks can vary, independently, with common values ranging from around 10 MPa for marble to over 400 GPa for tungsten carbide. Hardness values, measured on scales such as Rockwell or Vickers, can range from 50 HRC for some steels to over 90 HRA for tungsten carbide. Compressive modulus is also crucial, with values ranging from about 200 MPa for some aluminum alloys to over 3000 MPa for tungsten carbide. For example, the Young's modulus and/or compressive modulus may be at least 10 MPa, 20 MPa, 30 MPa, 40 MPa, 50 MPa, 60 MPa, 70 MPa, 80 Mpa, 90 MPa, 100 MPa, 120 Mpa, 150 Mpa, 175 MPa, 200 MPa, 500 MPa, 1 GPa, 5 Gpa, 10 GPa, 20 GPa, 30 GPa, 40 GPa, 50 GPa, 60 GPa, 70 GPa, 80 GPa, 90 GPa, 100 GPa, 120 GPa, 140 GPa, 160 GPa, 180 GPa, 200 GPa, 220 GPa, 250 GPa, 500 GPa, 1000 GPa, 2000 GPa, or 3000 GPa.

A variety of materials can be used for stop blocks in rolling machines, depending on the specific application requirements such as strength, durability, wear resistance, and cost-effectiveness. Metallic materials are compelling due to their high strength and durability. Hardened steels, such as AISI 4140, AISI 4340, AISI 1045, AISI 52100, D2 tool steel, and H13 tool steel, offer excellent mechanical properties for high-load applications. Stainless steels, including 17-4 PH, 304, and 316, provide corrosion resistance in harsh environments. Other high-performance metal options include tungsten carbide, titanium alloys like Ti-6Al-4V, and nickel-based superalloys such as Inconel 718 and Hastelloy C-276. Cobalt-based alloys like Stellite 6B, chromium-molybdenum (Chromoly) steels, and cast iron variants such as ductile iron (ASTM A536) and gray cast iron are also viable choices. For lightweight applications where strength-to-weight ratio is important, aluminum alloys like 7075-T6 and 6061-T6 may be considered.

In addition to metals, composite materials provide an excellent balance of strength and weight reduction. Carbon fiber reinforced polymers (CFRP), glass fiber reinforced polymers (GFRP), Kevlar-reinforced composites, phenolic laminates (such as G10 and FR4), and ultra-high molecular weight polyethylene (UHMW-PE) composites offer enhanced performance in specific environments. Aramid fiber composites also provide high strength and impact resistance while maintaining a relatively low weight.

For applications requiring extreme hardness, abrasion resistance, and high-temperature stability, ceramic materials can be utilized. Silicon carbide (SiC), boron carbide (B4C), alumina (Al₂O₃), zirconia (ZrO₂), titanium diboride (TiB₂), and cermets (ceramic-metal composites) are suitable for environments where wear resistance and thermal stability are critical.

Polymers and high-performance plastics serve as an alternative when non-marring, lightweight, or cost-effective solutions are needed. Materials such as UHMW-PE, polyetheretherketone (PEEK), polytetrafluoroethylene (PTFE/Teflon), acetal/Delrin (POM), high-density polyethylene (HDPE), nylon 6/6, polycarbonate (PC), and epoxy-based resin materials can be used, particularly in applications where metal-on-metal contact should be minimized.

Hybrid and specialty materials may provide unique advantages for specialized applications. Metal matrix composites (MMC), such as aluminum-silicon carbide (Al—SiC) and titanium-silicon carbide (Ti—SiC), combine the benefits of metals and ceramics for improved wear resistance and thermal stability. Reinforced concrete can be used for large-scale industrial setups requiring extreme load-bearing capacity. Tungsten-polymer blends offer impact resistance while reducing overall weight, and rubber-coated metal blocks can provide vibration damping in sensitive environments.

The choice of material for a stop block ultimately depends on factors such as load-bearing capacity, resistance to wear and corrosion, weight constraints, and environmental conditions. By selecting the appropriate material, the stop block can enhance both the safety and longevity of the rolling machine system.

Overall, the automated safety mechanism described provides an effective solution for enhancing safety protocols during roller maintenance in manufacturing plants. By automating the disengagement process and incorporating fail-safe features, the invention minimizes the risk of accidents and ensures the continued operation of the rolling system with optimal safety and efficiency. This mechanism not only improves worker safety but also enhances the reliability and uptime of the rolling systems by preventing damage that could occur from accidental roller closure. The integration of advanced materials and precise mechanical linkages ensures that the safety mechanism operates smoothly and effectively, providing a robust solution for modern manufacturing environments.

The stop block is automatically placed to prevent two rollers from collapsing on top of each other by an actuator or other mechanical means. In certain embodiments, the stop block may incorporate energy-absorbing elements to mitigate the impact force of an unintended roller collapse. This can be achieved through multi-layered designs, where a high-strength core, such as tungsten carbide, is surrounded by an energy-dissipating layer, such as reinforced rubber, polymer composites, or shock-absorbing foam. Additionally, for high-temperature environments, stop blocks may be made from thermally resistant materials such as ceramic composites or heat-treated alloys to withstand prolonged exposure to elevated temperatures without degradation. The selection of stop block materials and configurations depends on the specific application, ensuring optimal safety and durability in industrial settings.

### Actuators to Place Stop Block

Additionally, the specific mechanisms employed for mechanical extension or contortion that ultimately place a rigid material between the rollers to act as a block may vary widely. These mechanisms can include, but are not limited to, pistons, actuators, linear actuators, pneumatic actuators, hydraulic actuators, mechanical actuators, piezoelectric actuators, electric actuators, hybrid actuators, rotary actuators, solenoid actuators, diaphragm actuators, magnetic levitation actuators, hydraulic and pneumatic forces, electromagnetic forces, gears, chains, sprockets, levers, pulleys, cams, springs, racks and pinions, and other mechanical linkages or any combination of each of these. Each mechanism has unique advantages in terms of response time, force exertion, and reliability, making them suitable for different industrial applications depending on the specific requirements of the rolling system.

Furthermore, a wide range of materials may be utilized in constructing the automated safety mechanism. These materials include aluminum, chrome, steel, titanium, and various metal alloys known for their strength and durability. The choice of material depends on several factors, such as cost, weight, and compatibility with the rolling system. For instance, aluminum is lightweight and resistant to corrosion, making it suitable for environments where weight reduction is critical. Steel and titanium offer superior strength and durability, ideal for high-stress applications. Chrome provides excellent wear resistance, extending the lifespan of the safety mechanism.

The stop block itself, a critical component of the safety mechanism, can be constructed from materials such as hardened steel, tungsten carbide, or other high-strength composites. These materials are chosen for their ability to withstand significant compressive forces and resist wear and deformation over time. Hardened steel is particularly favored for its balance of strength and machinability, while tungsten carbide offers exceptional hardness and durability, albeit at a higher cost.

The mechanical properties of the materials used for the stop block and other components are paramount in ensuring the reliability and effectiveness of the safety mechanism. Key properties include tensile strength, compressive strength, hardness, and impact resistance. These properties ensure that the stop block can withstand the forces exerted by the rollers during operation and maintenance without failing or deforming. For example, a high tensile strength prevents the stop block from breaking under tension, while high compressive strength ensures it can resist the compressive forces exerted by the rollers.

The stop block may be securely mounted on a frame to function effectively. Additionally, the stop block should be large enough to act as a physical block between the rolling bodies or support bodies effectively. This ensures that even if an attempt is made to close the rollers during maintenance, the stop block will prevent the rolling bodies from collapsing, thereby protecting the operator from potential injury. The dimensions and positioning of the stop block should be carefully engineered to provide a reliable barrier that can endure the operational forces and maintain its blocking position securely.

Overall, the automated safety mechanism described herein provides an effective solution for enhancing safety protocols during roller maintenance in manufacturing plants. By automating the disengagement process and incorporating fail-safe features, the invention minimizes the risk of accidents and ensures the continued operation of the rolling system with optimal safety and efficiency. This mechanism not only improves worker safety but also enhances the reliability and uptime of the rolling systems by preventing damage that could occur from accidental roller closure. The integration of advanced materials and precise mechanical linkages ensures that the safety mechanism operates smoothly and effectively, providing a robust solution for modern manufacturing environments.

To ensure reliability, the actuator system may incorporate fail-safe redundancies that prevent unintended retraction of the stop block. For example, hydraulic or pneumatic actuators may include check valves that maintain pressure in the event of a power loss, preventing the stop block from disengaging unintentionally. Similarly, electromechanical actuators can feature self-locking mechanisms or braking systems that hold the stop block in place until an intentional command is given to retract. In another embodiment, a dual-actuation system may be employed, where a primary actuator deploys the stop block and a secondary locking mechanism, such as a mechanical latch or ratchet system, secures it in position. These additional safeguards ensure that the stop block remains engaged under all operating conditions, significantly reducing the risk of accidental roller collapse.

### First Embodiment

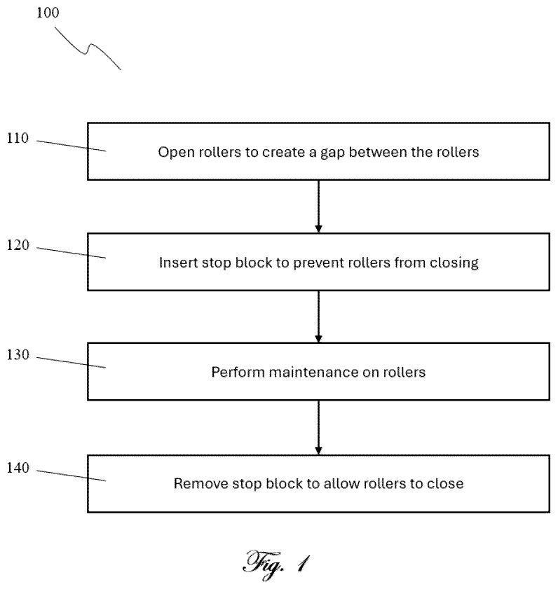

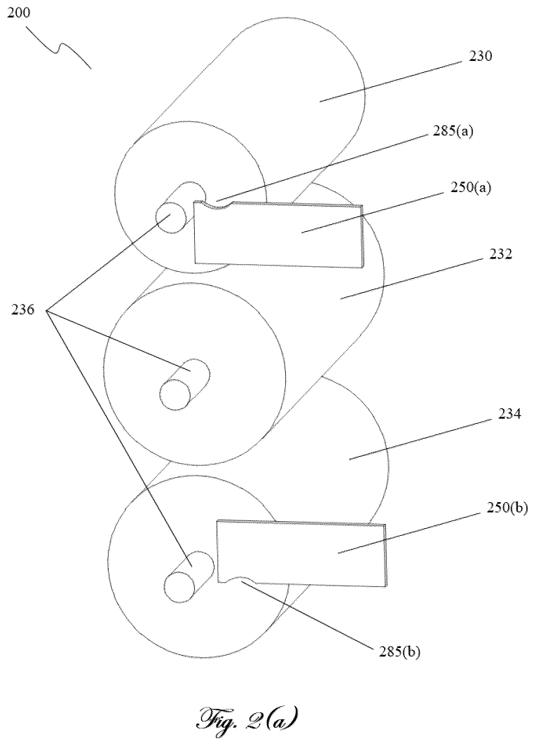

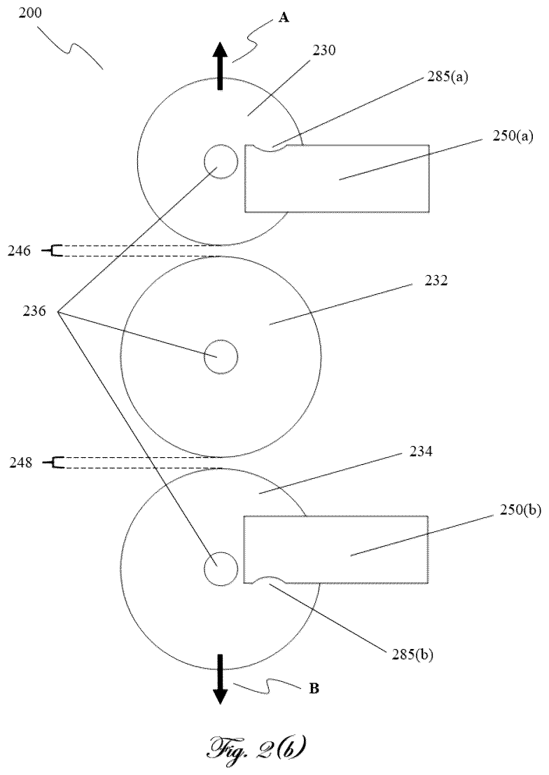

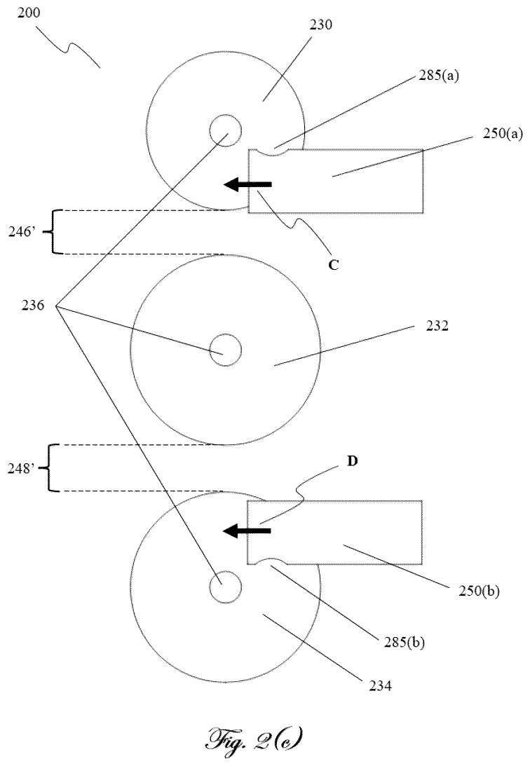

Turning to FIG. 1, a first embodiment of the invention is shown. Method 100 enhances safety during the maintenance of rolling systems in manufacturing plants. This method comprises four steps: opening the rollers—step 110, inserting a stop block—step 120, performing maintenance—step 130, and removing the stop blocks—step 140. Each step is detailed as follows:

Step 110: Opening Rollers to Create a Gap. In this step, the rollers are opened to create a gap sufficient for maintenance activities. When materials are being processed between two rollers, the gap may vary depending on the specific requirements, with distances such as 1/62″, 1/32″, 1/16″, ⅛″, ¼″, ⅜″, ½″, ⅝″, ⅞″, 1″, 1.5″, 2″, etc. These distances are too narrow for safe manual cleaning or maintenance. Therefore, the rolling machines are designed to separate the rollers to create a larger gap, sufficient for a hand or similar tool to fit between the rollers, thereby allowing safe cleaning and maintenance.

Step 120: Inserting a Stop Block to Prevent Rollers from Closing. In this step, a stop block is automatically inserted to prevent the rollers from closing. This may be achieved through an automated mechanism that can be activated by pressing a button or triggered automatically when the rollers are opened. The stop blocks are designed to be rigid and strong to withstand the forces exerted by the rollers. They can be mechanically fastened to the frame of the rolling machine, a wall, the ground, or any other sufficiently strong or anchored point; or designed as physical obstructions larger than a hand, ensuring they effectively block the rollers if they attempt to close and stop the rollers before the rollers close enough to injure a hand. The automated insertion system may operate independently from the roller control system, providing an additional safety layer to prevent accidental roller closure.

Step 130: Performing Maintenance or Cleaning. Technicians perform maintenance or clean the rollers while the stop blocks are in place. If an attempt is made to close the rollers during this time, the stop blocks act as mechanical stops, preventing the rollers from closing enough to injure the technician. This design prioritizes the safety of the technicians, even if it risks damaging the rolling machine, as preventing injury is paramount. To enhance safety further, the stop blocks may be designed with a slight clearance from the rollers, providing a warning through movement and noise if the rollers attempt to close. This warning allows technicians to react promptly and avoid potential injury.

Step 140: Removing the Stop Blocks. Once maintenance or cleaning is completed, the stop blocks are removed to allow the rollers to close. The removal process can be automated or manually controlled, ensuring that it only occurs when it is safe to do so. The stop blocks are designed to be visually identifiable, allowing technicians to easily confirm whether they are inserted or not. Additionally, a warning system can be integrated to provide visual, auditory, or other signals before the stop blocks are retracted. This system could include a horn, bright light, buzzer, chime, or other unique warning signals, providing an additional layer of safety by notifying nearby personnel of the impending change in roller status.

The method 100 described above provides a comprehensive approach to enhancing safety during the maintenance of rolling systems in manufacturing plants. By automating the insertion and removal of stop blocks and integrating independent control and warning systems, the invention ensures that maintenance activities can be performed safely and efficiently, minimizing the risk of injury to personnel and damage to equipment.

### Second Embodiment

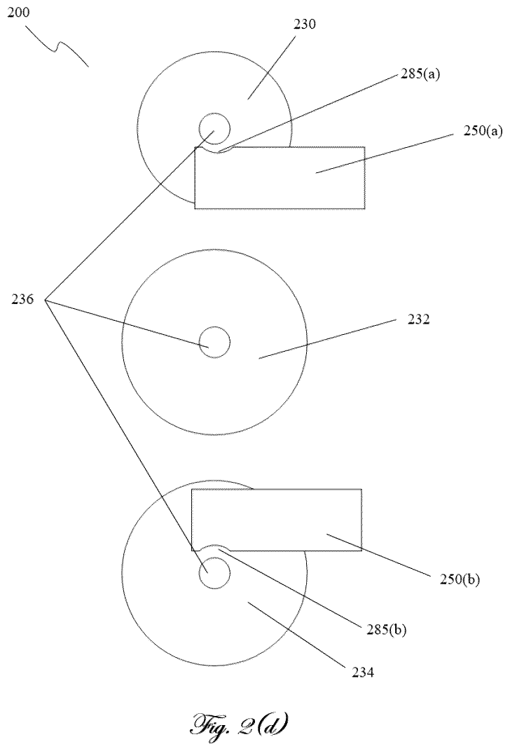

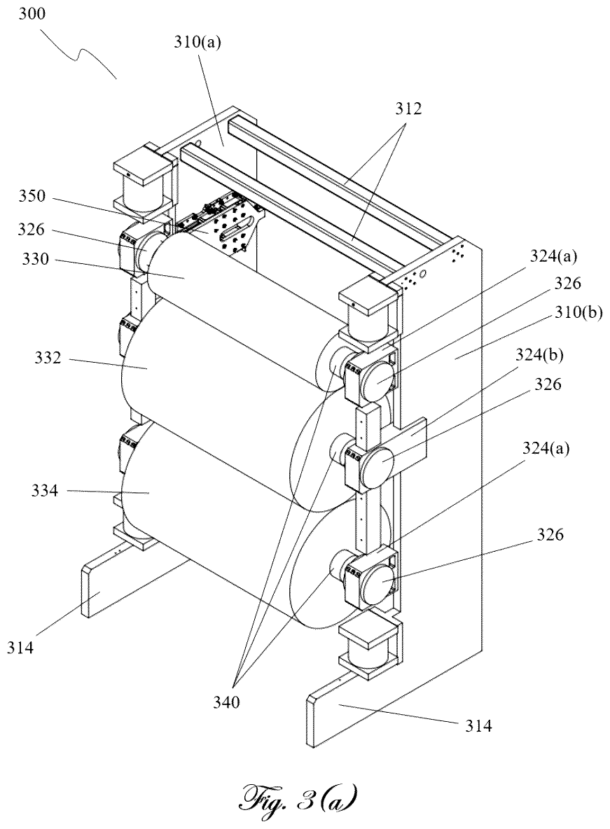

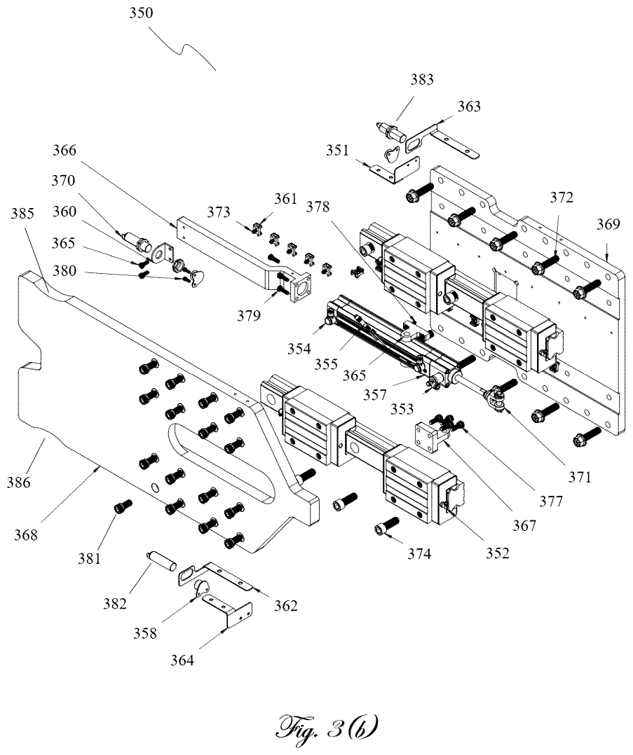

Turning now to FIG. 2(a)-2(d), a rolling machine with inventive stop blocks 250(a) and 250(b) is shown. In FIG. 2(a) (a perspective view of the rolling machine with the frame removed) and 2(b) (an orthogonal view of the rolling machine from the left side with the frame removed), roller bodies 230, 232, and 234 are mounted inside a frame (not shown) using each of their support bodies 236, arranged vertically on top of one another. Roller body 230 is positioned above roller body 232, which is in turn positioned above roller body 234. Each pair of rollers has a small gap between them: gap 246 between roller body 230 and roller body 232, and gap 218 between roller body 232 and roller body 234. Stop block 250(a) includes a stabilizing indentation 285(a) substantially in the shape of an arc with a radius large enough to accommodate a support body 236 if it begins to close. Stop block 250(b) includes a similar stabilizing indentation 285(b) with the same arc size and shape.

As shown in FIG. 2(b), direction A illustrates how roller 230 would move when the rollers are opening for maintenance. Direction B indicates the direction that roller body 234 would move to open gap 248 for cleaning or maintenance. Roller 232 may be mounted directly to the frame without the ability to move. In this position, gap 246 is a small amount of space between roller bodies 230 and 232, such that no tools, human hands, or human arms can reasonably be inserted for cleaning or maintenance. Gap 248 between roller bodies 232 and 234 are of similar size with similar constraints.

As shown in FIG. 2(c), after rolling body 230 moves up and rolling body 234 moves down, gaps 246 and 248 (as shown in FIG. 2(b)) widen to the gaps 246′ and 248′ as shown in FIG. 2(c). The increased size of this gap allows for objects, including a hand with a rag, scraper, or similar, to wipe, clean, and/or maintain the rolling bodies 230, 232, and 234 in the gaps 246′ and 246′. However, as shown, there is nothing that stops rolling bodies from collapsing back to the state they are shown in FIG. 2(b), which would decrease the size of gaps 246′ and 248′ to the smaller gaps 246 and 248. If an object, including a hand or arm, were between in gaps 246′ or 248′ when the rolling bodies 230, 232, and 234 collapsed, those objects may be destroyed, incurring a hand or arm and maiming the hand or arm's owner.

However, as shown here, stop block 250(a) can move following Direction C to act as a block to prevent rolling body 230 from collapsing down. Likewise, stop block 250(b) can move following Direction D to act as a block to prevent rolling body 234 from collapsing up. As shown in FIG. 2(c), stop blocks 250(a) and 250(b) are not tall enough to act as a physical block to prevent support bodies 236 from collapsing. While the skilled artisan could make that change, which is well within the ordinary skill of the art without undue experimentation, as shown here, stop blocks 250(a) and 250(b) are mounted on the frame (not shown) and slide on guides (not shown).

In FIG. 2(d), the final arrangement of rolling bodies 230, 232, and 234 and stop blocks 250(a) and 250(b) are shown in a fully deployed and engaged state. Here, if the rolling machine 200 tried to collapse the rolling bodies 230 and 234 on rolling body 232, the stop blocks 250(a) and 250(b) would physically prevent support bodies 236 on rolling bodies 230 and 234 from moving, thereby preventing the rolling bodies 230, 232, and 234 from collapsing together.

Here is a discussion comparing the first and second embodiments to be inserted at the bottom of Embodiment 2:

### Third Embodiment

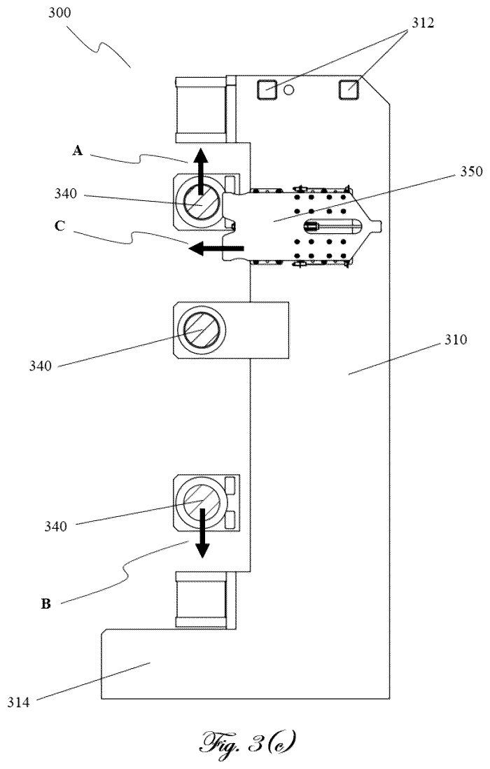

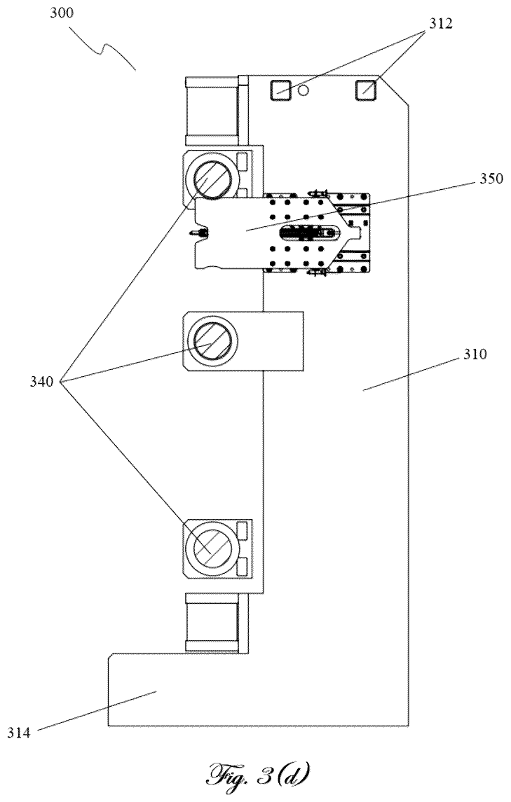

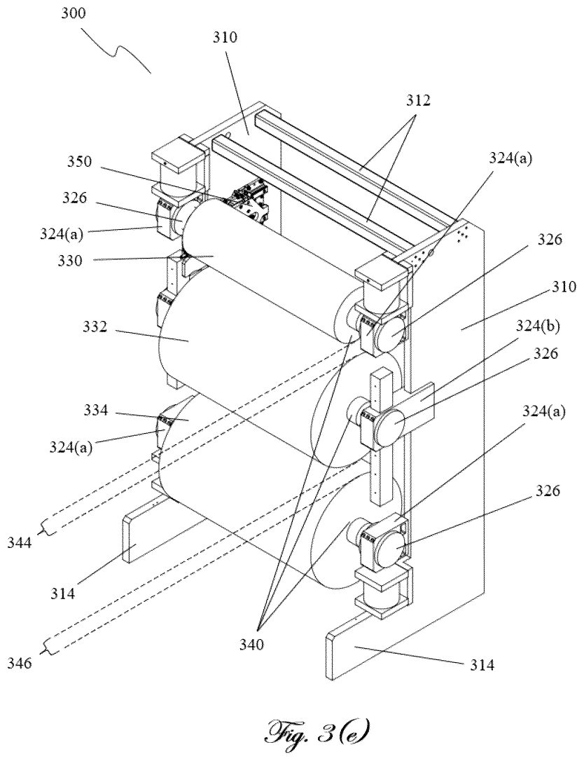

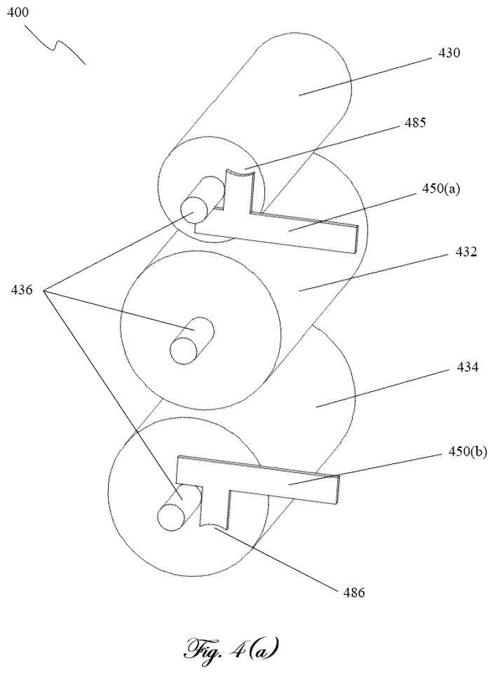

Turning now to FIG. 3(a)-3(e), rolling machine 300 is shown. In FIG. 3(a) is a perspective view of the rolling machine. Top rolling body 330 sits above middle rolling body 332, which in turn sits above bottom rolling body 334. As shown, top rolling body has a smaller diameter 330 than the middle rolling body 332 or the bottom rolling body 334, which need not be the case as described elsewhere in this specification. Left frame 310(a) sits to the left of the top rolling body 330, middle rolling body 332, and bottom rolling body 334 when looking at the rolling machine 300 from the front, and it supports their weight. Likewise, right frame 310(b) sits to the right of the top rolling body 330, middle rolling body 332, and bottom rolling body 334 and supports their weight. Each of the top rolling body 330, middle rolling body 332, and bottom rolling body 334 is supported by support bodies 340. Support bodies 340 feed through peripheral frame-roller supports 324(a) and middle frame-roller supports 326(b) to bear the weight of the support bodies 340 and thus the top rolling body 330, middle rolling body 332, and bottom rolling body 334. Peripheral frame-roller supports 324(a) and middle frame-roller supports 326(b) may be integrated with or mechanically attached to the frame. Additionally, support bodies 340 may be connected to the peripheral frame-roller supports 324(a) and middle frame-roller supports 326(b), which ultimately creates the support necessary to bear the weight of top rolling body 330, middle rolling body 332, and bottom rolling body 334 by the frame. Feet 314 bear the forward weight of the rolling machine 300. These feet 314 prevent the rolling machine 300—which is front heavy because of the weight of the heavy top rolling body 330, middle rolling body 332, and bottom rolling body 334—front toppling forward on itself or an unfortunate passerby. Moreover, frame joints 312 hold left frame 310(a) a predetermined distance from right frame 310(b), so that the rolling machine 300 is rigid and holds its shape. Stop block 350 is connected to left frame 310(a) (shown) and another stop block 350 is connected to right frame 310(b) (not shown) at the same height and mirroring the former across the rolling machine 300.

The structure of the stop block 350—a stop block according to one aspect of the invention—is shown in FIG. 3(b). Base plate 369 mounts directly to the frame—left frame 310(a) from FIG. 3(a)—as shown. Screws 372 penetrate base plate 369 and mate with the frame of the rolling machine 300. Linear bearing assemblies 352 facilitates lock plate 368 to linearly slide relative to base plate 369. Lock plate 368 has divot 385 to mate with a support body 340 (shown in FIG. 3(a)) above it and divot 386 to mate with another support body 340 below it (also shown in FIG. 3(a)). Screws 374 secure the two linear bearing assemblies 352 to base plate 369, one linear bearing assembly 352 at the top and the other at the bottom of base plate 369. Screws 381 secure lock plate 386 to the other side of linear bearing assemblies 352. The flat section of cylinder bracket 367 mates with the interior face of lock plate 368, secured by screws 377. Additionally, cylinder bracket 367 mates with clevis 371 of the locking air cylinder 357. Air cylinder 357 has elbow 353, elbow 354, and proximity sensor 355. Trunnion mount 365 is screwed into base plate 369 using screws 378, which allows air cylinder 357 to slide linearly. Sensor bracket 366 attaches to the end of the end of air cylinder 357, secured by screws 379. Cable guides 361 are secured to the top of sensor bracket 366 by screws 373, which allows cables to be safely run down the length of sensor bracket 366. At the top of sensor bracket 366, two holes allow sensor and switch mounting bracket 360 to mate with the sensor bracket 366 with screws 365. Installed on sensor and switch mounting bracket 360 is a plastic barrel sensor/actuator 370 which penetrates the opening in the sensor and switch mounting bracket 360 and is secured in place by socket head screw 380. Sensor brackets 351, 362, 363, and 364 work to hold plastic barrel sensor/actuators 382 and 383. The three plastic barrel sensor/actuators 370, 382, and 383 work together to locate rollers, which can be control prompts in software telling the device whether it should extend or not.

Turning to FIG. 3(c), a cross-section of rolling machine 300 is shown. Frame 310 has stop block 350 mounted thereon. To orient yourself, consider that frame joints 312 are at the top, and foot 314 is at the bottom. Rolling bodies 330, 332, and 334 are not shown. However, support bodies 340 are (support caps 326 are not shown in this cross-section). This figure demonstrates the deployment of the stop block 350. First, either together or separately, the upper support body 340 rises following movement A and the lower support body 340 drops down following movement B. After these movements are completed or during those movements, stop block 350 extends. In the case of the top support body 340, stop block 350 moves following movement C under the support body 340 so that the support body cannot go back into the engaged position. Likewise, another stop block (not shown) may move above lower support 340, so that lower support 340 cannot close or move back to where it began. FIG. 3(d) shows the components after movement C is completed and the stop block 350 is deployed. In this way, the stop block 350, having extended into the path of the uppermost support roller 340, blocks the support roller 340 from returning to its manufacturing position. When deployed, this opens the gap 344 between the top rolling body 330 and the middle rolling body 332. If a user inadvertently tries to return rolling body 330 back to its manufacturing position while someone is maintaining, cleaning, or otherwise performing maintenance on rolling machine 300, top rolling body 330 cannot collapse to injury that person because stop block 350 is extended and in the way. Likewise, similar can exist on the bottom, even though it is not shown in these figures.

This embodiment shows a single stop block 350, however, it is envisioned with one or more stop blocks. For example, there may be a stop block for the top roller, another for the bottom roller, and then additional stop blocks on each side of the rolling machine. Moreover, each moving roller may have its own stop block, including those embodiments with more than 3 rollers.

### Fourth Embodiment

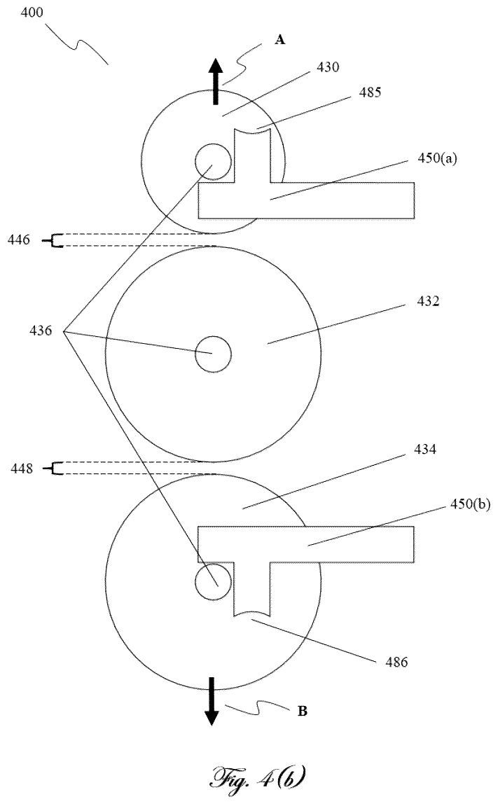

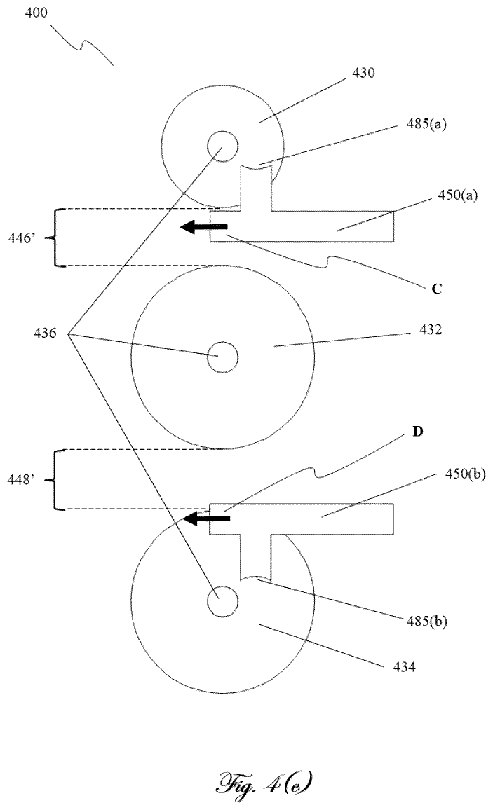

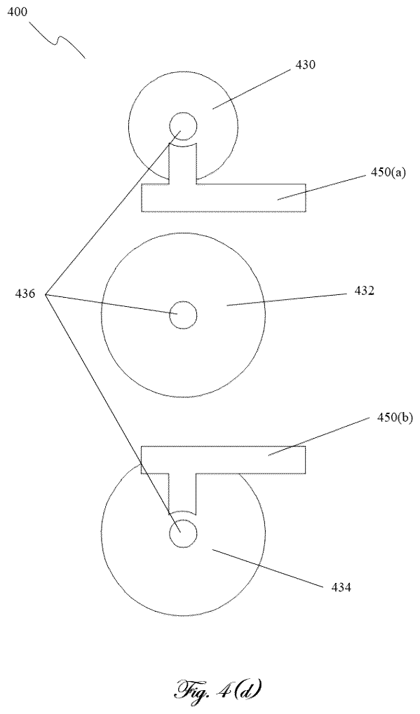

Turning now to FIG. 4(a)-4(d), a rolling machine with inventive t-slider stop blocks 450(a) and 450(b) is shown. In FIG. 4(a) (a perspective view of the rolling machine with the frame removed) and 4(b) (an orthogonal view of the rolling machine from the left side with the frame removed), roller bodies 430, 432, and 434 are mounted inside a frame (not shown) using each of their support bodies 436, arranged vertically on top of one another. Roller body 430 is positioned above roller body 432, which is in turn positioned above roller body 434. Each pair of rollers has a small gap between them: gap 446 between roller body 430 and roller body 432, and gap 418 between roller body 432 and roller body 434. T-slider stop block 450(a) includes a stabilizing indentation 485(a) substantially in the shape of an arc with a radius large enough to accommodate a support body 436 if it begins to close. T-slider stop block 450(b) includes a similar stabilizing indentation 485(b) with the same arc size and shape.

As shown in FIG. 4(b), direction A illustrates how roller 430 would move when the rollers are opening for maintenance. Direction B indicates the direction that roller body 434 would move to open gap 448 for cleaning or maintenance. Roller 432 may be mounted directly to the frame without the ability to move. In this position, gap 446 is a small amount of space between roller bodies 430 and 432, such that no tools, human hands, or human arms can reasonably be inserted for cleaning or maintenance. Gap 448 between roller bodies 432 and 434 are of similar size with similar constraints.

As shown in FIG. 4(c), after rolling body 430 moves up and rolling body 434 moves down, gaps 446 and 448 (as shown in FIG. 4(b)) widen to the gaps 446′ and 448′ as shown in FIG. 4(c). The increased size of this gap allows for objects, including a hand with a rag, scraper, or similar, to wipe, clean, and/or maintain the rolling bodies 430, 432, and 434 in the gaps 446′ and 448′. However, as shown, there is nothing that stops rolling bodies from collapsing back to the state they are shown in FIG. 4(b), which would decrease the size of gaps 446′ and 448′ to the smaller gaps 446 and 448. If an object, including a hand or arm, were between in gaps 446′ or 448′ when the rolling bodies 430, 432, and 434 collapsed, those objects may be destroyed, incurring a hand or arm and maiming the hand or arm's owner.

However, as shown here, t-slider stop block 450(a) can move following Direction C to act as a block to prevent rolling body 430 from collapsing down. Likewise, t-slider stop block 450(b) can move following Direction D to act as a block to prevent rolling body 434 from collapsing up. As shown in FIG. 42(c), t-slider stop blocks 450(a) and 450(b) are not tall enough to act as a physical block to prevent support bodies 436 from collapsing. While the skilled artisan could make that change, which is well within the ordinary skill of the art without undue experimentation, as shown here, t-slider stop blocks 450(a) and 450(b) are mounted on the frame (not shown) and slide on guides (not shown).

In FIG. 4(d), the final arrangement of rolling bodies 430, 432, and 434 and t-slider stop blocks 450(a) and 450(b) are shown in a fully deployed and engaged state. Here, if the rolling machine 400 tried to collapse the rolling bodies 430 and 434 on rolling body 432, the t-slider stop blocks 450(a) and 450(b) would physically prevent support bodies 436 on rolling bodies 430 and 434 from moving, thereby preventing the rolling bodies 430, 432, and 434 from collapsing together.

Fifth Embodiment

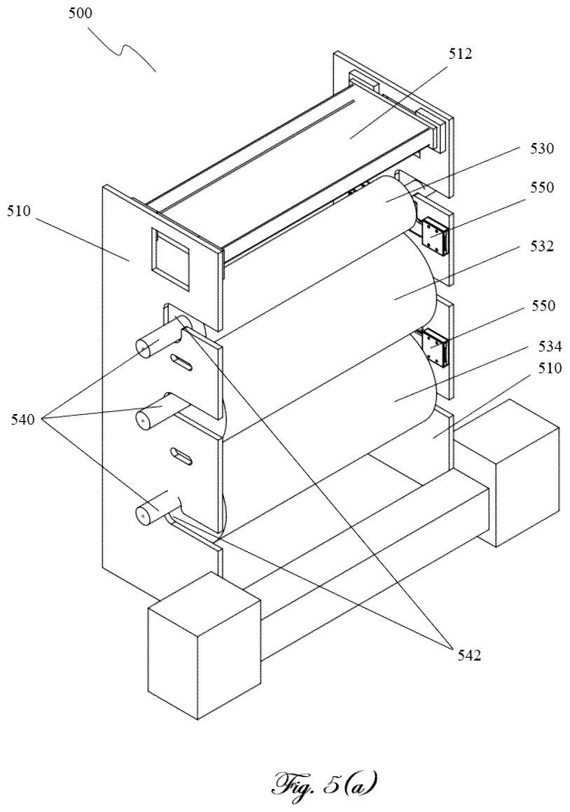

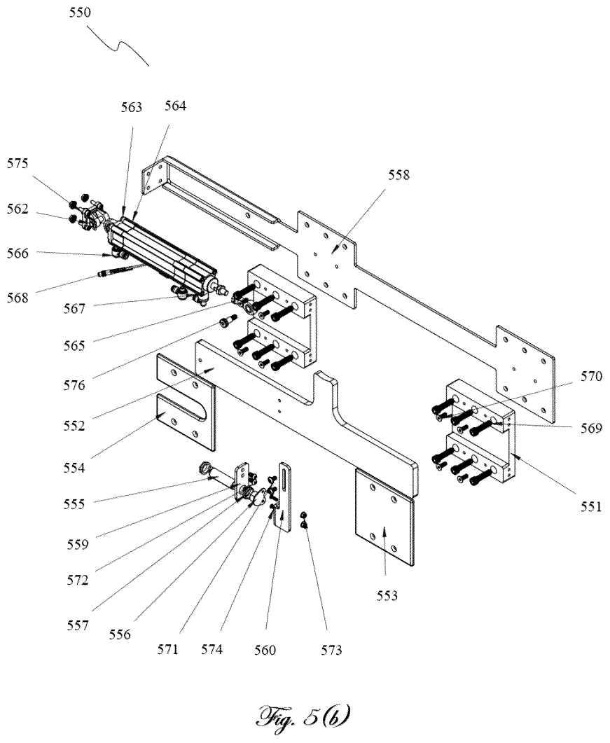

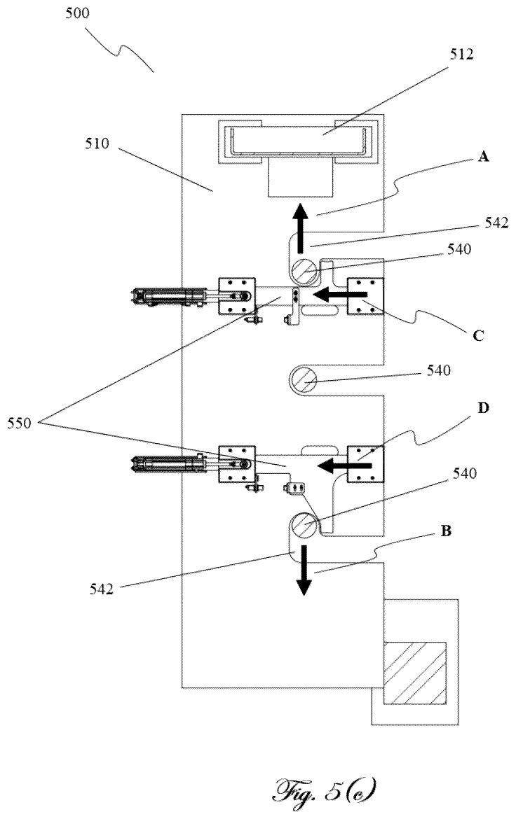

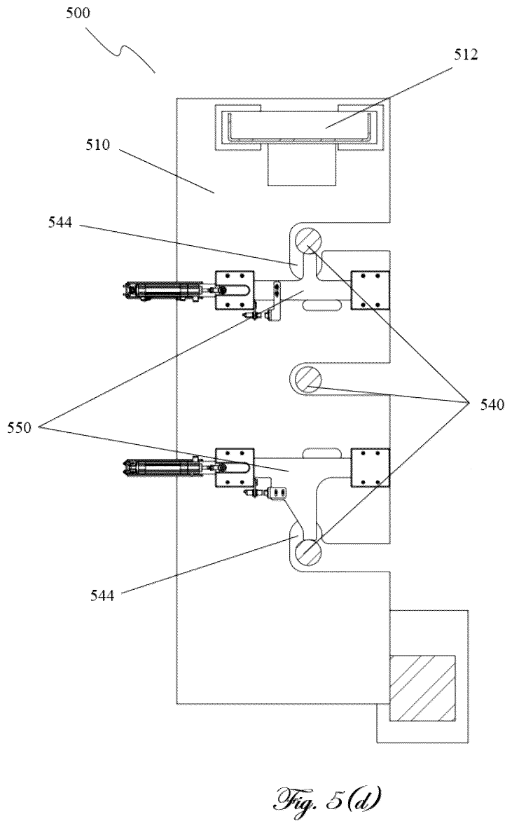

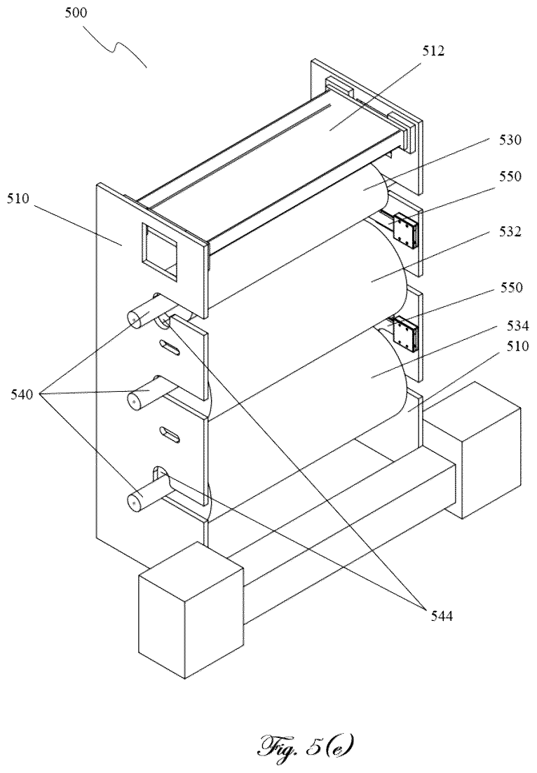

Turning now to FIG. 5(a)-5(e), rolling machine 500 is shown. In FIG. 5(a) is a perspective view of the rolling machine. Top rolling body 530 sits above middle rolling body 532, which in turn sits above bottom rolling body 534. As shown, top rolling body has a smaller diameter 530 than the middle rolling body 532 or the bottom rolling body 534, which need not be the case as described elsewhere in this specification. Frame siding 510 generally bounds both the left and the right of the rolling machine 500. Frame siding 510 generally supports the weight the rolling bodies 530, 532, and 534. Each of the top rolling body 530, middle rolling body 532, and bottom rolling body 534 is supported by support bodies 540. Moreover, top frame housing 512 hold frame sidings 510 together, so that the rolling machine 500 is rigid and holds its shape. T-slider stop block 550 is connected to frame siding 510.

The structure of the t-slider stop block 550—a stop block according to one aspect of the invention—is shown in FIG. 5(b). Actuator bracket 558 is secured to the frame siding 510 screws 569, 570, and 576, which also secure guide blocks 551. Bar bump 552 can slide between the guide blocks 551. Cover plate 553 and slotted cover plate 554 are secured to guide blocks 551 to sandwich bump bar 552 in place. Sensor 555 is installed in sensor base plate 559 by screws 572, nut 557, and target 556. These are mated and screwed into upper target bracket 560 by screws 571, 574 and 573. Cylinder assembly 564 is attached to or integrated with female swivel flange assembly 563 which in turn mates with male swivel flange assembly 562 and secured by flange washout nuts 575. Additionally, the cylinder assembly 564 comprises elbows 566 and 567 and proximity sensor 568. The other end of the cylinder assembly 564 mates with rod eye 15.

Turning to FIG. 5(c), a cross-section of rolling machine 300 is shown. Frame 510 has t-slider stop block 550 mounted thereon. To orient yourself, consider that top frame 512 is at the top. Rolling bodies 530, 532, and 534 are not shown. However, support bodies 540 are shown. This figure demonstrates the deployment of the t-slider stop block 550. First, either together or separately, the upper support body 540 rises in cutout 542 following movement A and the lower support body 540 drops down into cutout 542 following movement B. After these movements are completed or during those movements, t-slider stop block 550 extends. In the case of the top support body 540, t-slider stop block 550 moves following movement C under the support body 540 so that the support body cannot go back into the engaged position. Likewise, another stop block (not shown) may move above lower support 540, so that lower support 540 cannot close or move back to where it began. FIG. 5(d) shows the components after movement C is completed and the stop block 550 is deployed. In this way, the t-slider stop block 550, having extended into the path of the uppermost support roller 540, blocks the support roller 540 from returning to its manufacturing position. When deployed, this opens the slot 544 between the top rolling body 530 and the middle rolling body 532. If a user inadvertently tries to return rolling body 530 back to its manufacturing position while someone is maintaining, cleaning, or otherwise performing maintenance on rolling machine 500, top rolling body 530 cannot collapse to injury that person because stop block 550 is extended and in the way.

### Sixth Embodiment

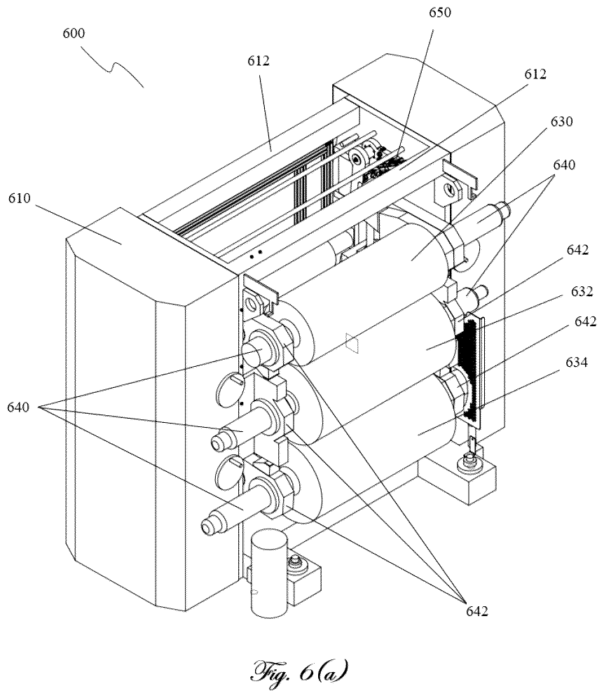

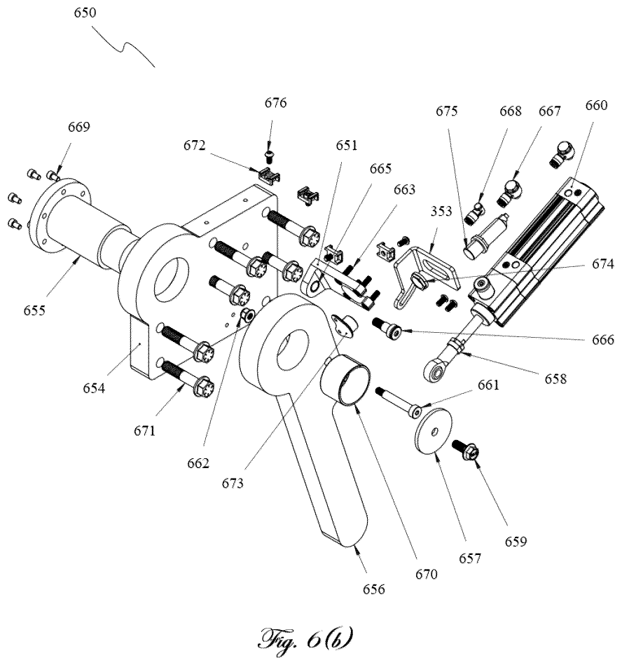

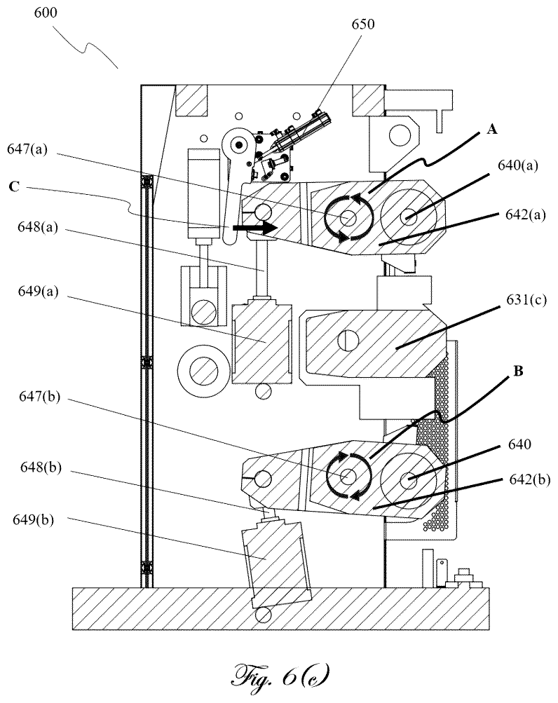

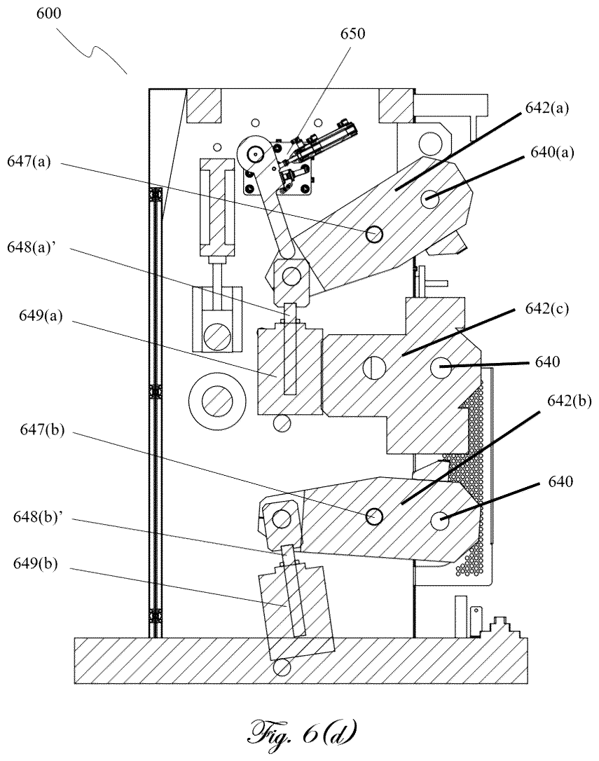

Turning now to FIG. 6(a)-6(d), rolling machine 600 is shown. In FIG. 6(a) is a perspective view of the rolling machine. Top rolling body 630 sits above middle rolling body 632, which in turn sits above bottom rolling body 634. As shown, top rolling body has a smaller diameter 630 than the middle rolling body 632 or the bottom rolling body 634, which need not be the case as described elsewhere in this specification. Frame siding 610 sits to the left and right of the rolling bodies 630, 632, and 634 when looking at the rolling machine 600 from the front, and it supports their weight. Each of the rolling bodies 630, 632, and 634 are supported by support bodies 640. Support bodies 640 feed through frame-roller supports 642 and middle frame-roller supports. Frame-roller supports 642 may be integrated with or mechanically attached to the frame. Here, they are attached with screws (not shown). Additionally, support bodies 640 may be connected to the frame-roller supports 624, which ultimately creates the support necessary to bear the weight of rolling bodies 630, 632, and 634 by the frame. Moreover, frame joists 612 hold frame siding 610 a predetermined distance from its opposing frame siding 610 on the other side of the rolling machine 600. This enables the rolling machine 600 to maintain its rigidity and hold its shape. Stop block mechanism 650 is connected to the frame siding 610.

The structure of the stop block mechanism 650—a stop block according to one aspect of the invention—is shown in FIG. 6(b). Mounting plate 654 mounts directly to the frame siding 610 from FIG. 6(a). It is secured to the frame siding 610 using screws 671. Round bolt pin 655 penetrates the frame siding 610 from the outer face and is secured thereto by screws 669. Round bolt pin 655 mates through an opening in mounting plate 654 mounted on the inner surface of the frame siding 610 and ultimately through bump bar 656 to create a pivot point. Collar 670 allows the bump bar 656 to rotate, and washer 657 and screw 659 secure the bump bar 6 to the end of round bolt pin 655. The shoulder is secured using lock nut 12 and screw 11.

Linear actuator assembly 660 mounts the backside of bump bar 656 using clevis 558 to control bump bar 656's extension by extending or contracting. Cylinder bracket 651 mounts to mounting plate 664 using screw 666 and sleeve 665. Cable ties 672 are mounted to mounting plate 664 using screws 676.

Sensor 675 is mounted on sensor bracket 653 using barrel nut 674 and target 673. Sensor bracket 653 may be mounted almost anywhere, but here it is mounted on cylinder bracket 651 by screws 663. Elbows 667 and 668 connect linear actuator 660 to the mounting bracket 664. In use, linear actuator 110 may activate to deploy or retract the bump bar 656. Sensor 675 may control the system.

Turning to FIG. 6(c), a cross-section of rolling machine 600 is shown. Frame 610 has stop block 650 mounted thereon. However, support bodies 640 are shown as 640 top support body 640(a), bottom support body 640(b), and middle support body 640(c) (FIG. 6(d) only). This figure demonstrates the engagement of the stop block mechanism 650. First, either together or separately, the upper frame-roller support 642(a) pivots around axis 647(a) following movement A causing the entire frame-roller support 642(a) to lift the roller support 640(a), widening the gaps between roller bodies 630 and 632 (not shown). This is powered by linear actuator 649(a) pulling actuator rod 648(a) to extension 648(a)′ (FIG. 6(d)). Likewise, bottom frame-roller support 642(b) pivots around axis 647(b) following movement B, causing the frame-roller support 642(b) to drop the roller support 640(b), widening the gaps between roller bodies 632 and 634. This is powered by linear actuator 649(b) extending actuator rod 648(b) to extension 648(b)′ (FIG. 6(d)). After these two movements complete, then mechanism 650 can activate and move its bump bar 656 (unlabeled in this figure) into place following movement C to create the condition as shown in FIG. 6(d), where the bump bar 656 (unlabeled in this figure) prevents linear actuator 649(a) from extending rod 648(a)′.

### Seventh Embodiment

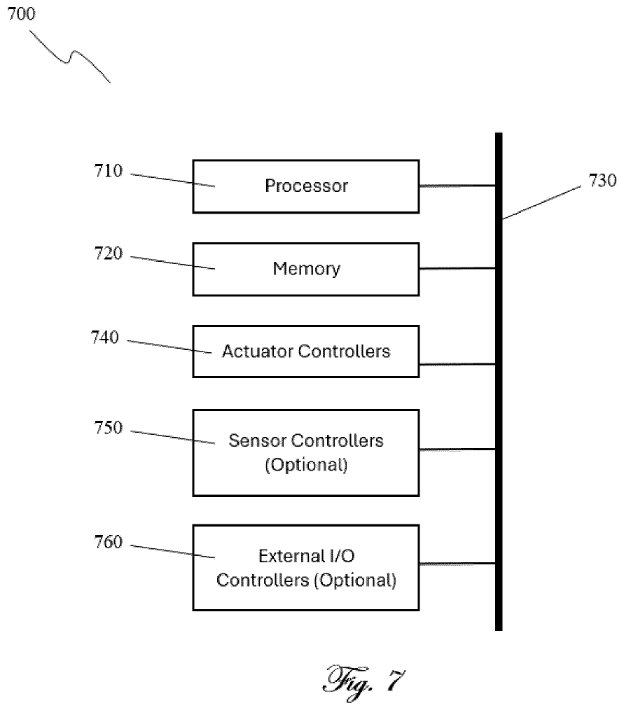

Turning now to FIG. 7, a control system 700 is shown that automates the deployment of stop blocks to prevent roller collapse in a rolling machine. Unlike previous embodiments, which focus on the mechanical implementation of stop blocks, this embodiment integrates an electronic control unit that governs the movement of the stop blocks via actuators. This control mechanism enhances safety, ensures precise deployment, and minimizes human error in engaging the stop blocks.

Control system 700 comprises a processor 710, memory 720, data bus 730, actuator controllers 740, optional sensor controllers 750, and optional external I/O controllers 760. The processor 710 is operatively connected to the memory 720 and communicates via data bus 730, which may be a shared system bus or an independent, dedicated bus.

The memory 720 stores control instructions that dictate the movement of the stop blocks and optionally stores firmware for system updates and performance enhancements. The memory 720 may also store multiple operation modes and configuration settings for various use cases. The memory 720 may store instructions for multiple operation modes, including:
Automatic Mode: The stop blocks deploy as soon as the rollers reach a predetermined maintenance position.
Manual Override Mode: A technician can manually engage or disengage the stop blocks via an interface connected through the external I/O controller 760, such as a touchscreen display, physical control panel, or button.
Safety Lock Mode: The system prevents the rollers from resuming normal operation until a technician confirms the removal of stop blocks via an input command.

The actuator controllers 740 govern the operation of actuators responsible for deploying and retracting the stop blocks. The actuator controllers 740 may be integrated directly into the actuators or provided as independent control units that interface with the actuators via wired or wireless connections. In some embodiments, the entire control system 700 may be integrated into the actuators, creating a self-contained, intelligent actuation module.

Optional sensor controllers 750 facilitate real-time monitoring of roller positions and actuator states. The sensor controllers 750 may interface with position sensors that detect whether the rollers are attempting to collapse, whether the actuators are deployed, retracted, or in motion. These sensors provide feedback to processor 710, allowing the control system 700 to make real-time adjustments to actuator deployment as needed. In certain embodiments, control system 700 may function without sensors, relying on preset deployment timing or operator input.

Optional external I/O controllers 760 enable user interaction and system management. These controllers may support interfaces such as keyboards, monitors, touchscreen displays, or other user input devices. The external I/O controllers 760 may also facilitate system diagnostics, firmware updates, and configuration modifications. In some embodiments, a technician may connect an external computing device to update the system firmware or adjust operational parameters.

In one embodiment, an alarm is configured as an output device coupled to the external I/O controller 760. Memory 720 has instructions that, when processed by processor 710, monitor real-time data from sensor controllers 750, such that if the system has deployed the stop blocks to prevent rollers from collapsing that the sensor controllers 720 provided data suggesting the rollers are nevertheless attempting to collapse, the alarm may arm, warning users of potential danger.

The control system 700 is designed to be adaptable and modular, allowing different configurations depending on the specific application. The integration of actuator controllers 740 within the actuators enables a streamlined design, while the optional sensor controllers 750 and external I/O controllers 760 provide flexibility for enhanced automation and user interaction. The combination of these components ensures a robust and intelligent control system for preventing roller collapse in rolling machines.

The control system 700 is designed to integrate with existing safety interlocks and emergency stop mechanisms to provide an additional layer of safety. In one embodiment, control system 700 is configured to interface with an emergency stop (E-stop) system. When an E-stop signal is detected, processor 710 immediately halts actuator movements and locks the stop blocks in a deployed state to ensure that the rollers cannot collapse while maintenance or troubleshooting is being conducted. The E-stop mechanism may be triggered manually via a physical emergency stop button, or automatically if anomalous conditions, such as unexpected roller movement, are detected by sensor controllers 750.

The system may also incorporate interlock switches that prevent the rolling machine from operating unless the stop blocks are fully deployed or retracted, as required for safe operation. These interlocks may include:
Mechanical Interlocks: Physical barriers that can be engaged before actuators can operate.
Electrical Interlocks: Circuits that disable the rolling machine when stop blocks are deployed or when safety conditions are not met.
Software-Based Interlocks: Logical conditions within processor 710 that prevent unauthorized or unsafe stop block retraction unless predefined safety criteria are satisfied.

Additionally, the external I/O controller 760 may enable technicians to override or reset safety interlocks if necessary, provided that they follow a secure access protocol. This may include multi-step verification through an operator interface or requiring supervisor authorization before overriding automatic safety mechanisms. The integration of safety interlocks ensures that the system functions reliably and minimizes the likelihood of human error or system malfunctions that could lead to injury or damage.

The electronic control system may include a real-time feedback loop that continuously monitors the position of the stop blocks and actuators, ensuring proper engagement. Sensors such as optical encoders, Hall-effect sensors, or strain gauges can detect stop block deployment and provide confirmation signals to the processor. Additionally, the control system may incorporate automated diagnostics that periodically test actuator function, sensor accuracy, and stop block integrity. In networked environments, the control system may be integrated with industrial communication protocols such as Modbus, EtherCAT, or OPC UA, allowing seamless interaction with factory automation systems. This connectivity enables remote monitoring, predictive maintenance alerts, and data logging for compliance and operational optimization.

### Automatic Deployment of Stop Blocks

The method for automatic stop block deployment may be initiated through various event-based triggers. These triggers include scheduled maintenance mode activation, roller positional changes exceeding preset thresholds, emergency stop signal detection, or operator input via a human-machine interface (HMI). Furthermore, an override safety protocol may be implemented to allow manual intervention in case of system malfunctions. This could include a two-step authentication process requiring dual confirmation before retracting the stop block, ensuring that removal only occurs when the roller system is safe. Additional safety checks, such as visual or audible alerts, may accompany any manual override actions, providing further safeguards against accidental disengagement.

### Intent of Disclosure and Definitions

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

We claim:

1. An automated safety mechanism for a rolling machine, comprising:
a frame supporting at least one rollers and a hard surface;
a mechanical extension mechanism configured to move the stop block between a retracted position and a deployed position; and
a mounting assembly securing the stop block to the frame;
wherein in the deployed position, the stop block physically prevents the roller from collapsing to the hard surface; and
wherein in the retracted position, the stop block does not physically prevent the roller from collapsing to the hard surface.

2. The automated safety mechanism of claim 1, wherein the mechanical extension mechanism is selected from the group consisting of pistons, hydraulic actuators, pneumatic actuators, linear actuators, rotary actuators, and mechanical linkages.

3. The automated safety mechanism of claim 1, wherein the stop block is configured with an indentation shaped to conform to the surface of the roller.

4. The automated safety mechanism of claim 1, wherein the stop block is coupled to a locking mechanism that prevents unintended retraction when the rolling machine is in a maintenance state.

5. The automated safety mechanism of claim 1, wherein the stop block is designed to be retrofittable onto existing rolling machines.

6. The automated safety mechanism of claim 1, wherein the stop block is constructed with an energy-absorbing material to mitigate impact forces if the roller attempts to collapse.

7. An electronic control system for an automated safety mechanism in a rolling machine, comprising:
a processor;
a memory storing control instructions for operating a stop block;
an actuator controller operatively coupled to a mechanical extension mechanism for deploying the stop block; and
a communication bus facilitating data exchange between the processor, memory, and actuator controller.

8. The electronic control system of claim 7, further comprising a sensor controller operatively coupled to at least one sensor configured to detect the real-time position of the roller and/or the stop block.

9. The electronic control system of claim 7, further comprising an external I/O controller configured to communicate with a user interface device for system diagnostics, firmware updates, controls, and/or operational adjustments.

10. The electronic control system of claim 7, wherein the actuator controller is configured to receive a fail-safe signal to lock the stop block in a deployed position in the event of system failure.

11. The electronic control system of claim 7, further comprising a wireless communication module configured to transmit system status updates to a remote monitoring device.

12. A method for automatically deploying a stop block in a rolling machine, comprising:
detecting a roller movement indicative of a maintenance state;
transmitting a control signal to an actuator;
activating the actuator to move a stop block from a retracted position to a deployed position; and
preventing the roller from collapsing by engaging the stop block in the deployed position.

13. The method of claim 12, further comprising determining a deployment condition based on sensor data monitoring the real-time position of the roller.

14. The method of claim 12, further comprising transmitting an alert to an operator confirming successful deployment of the stop block.

15. The method of claim 12, wherein the actuator is selected from the group consisting of pneumatic actuators, hydraulic actuators, linear actuators, and mechanical linkages.

16. The method of claim 12, wherein the stop block remains deployed until an operator acknowledges a system prompt to retract it.

17. The method of claim 12, further comprising executing a safety lock mode in which the rolling machine remains inoperable until a confirmation signal is received.

18. The method of claim 12, further comprising detecting an anomaly in roller movement and initiating an emergency deployment of the stop block.

19. The method of claim 12, wherein the stop block deployment is triggered when the roller reaches a predetermined maintenance position.

20. The method of claim 12, further comprising verifying successful deployment through a feedback loop incorporating position sensors.
